(19) United States
(12) Patent Application Publication
(10) Pub. No.: US 2008/0047773 A1
(43) Pub. Date: Feb. 28, 2008

(54) MOTION TRANSFER SYSTEM

(76) Inventor: David Halliday, Maple Ridge (CA)

Correspondence Address: PATTERSON & SHERIDAN, L.L.P., 3040 POST OAK BOULEVARD, SUITE 1500, HOUSTON, TX, 77056, US

(21) Appl. No.: 11/846,398

(22) Filed: Aug. 28, 2007

Related U.S. Application Data
(63) Continuation of application No. 60/823,724, filed on Aug. 28, 2006.

(51) Int. Cl. B62D 5/00

(52) U.S. Cl. 180/400

(57) ABSTRACT

The present invention generally relates to a motion transfer system that is capable of moving along a variable rack. In one aspect, a motion transfer system for moving an object along a path is provided. The system includes a variable rack having at least one straight section and at least one curved section and a drive system. The drive system includes a drive motor for supplying energy to the drive system, a rotatable pinion operatively connected to the drive motor, and a plurality of rollers disposed around the rotatable pinion, wherein the rollers are configured to self align as the pinion meshes with the variable rack. In another aspect, a method of moving an object along a variable rack having at least one straight section and at least one curved section is provided. In a further aspect, a motion transfer system is provided.

### CROSS-REFERENCE TO RELATED APPLICATIONS

This application claims benefit of U.S. provisional patent application Ser. No. 60/823,724, filed Aug. 28, 2006, which is herein incorporated by reference in its entirety.

### BACKGROUND OF THE INVENTION

1. Field of the Invention

Embodiments of the present invention generally relate to a system for moving an object along a path. More particularly, embodiments of the present invention relate to a motion transfer system having a pinion with a plurality of self aligning rollers that are configured to mesh with a variable rack.

2. Description of the Related Art

A conventional rack and pinion is a mechanical device consisting of a linear bar having teeth on one side that mesh with teeth on a small gear. The bar is commonly referred to as a conventional rack and the small gear is commonly referred to as a conventional pinion. If the pinion rotates about a fixed axis, the rack will move in a straight path. This type of conventional rack and pinion arrangement is common in a variety of different machines. For instance, an automobile steering mechanism typically includes a rack and pinion drive that employs this principle.

In another conventional rack and pinion arrangement, the rack is fixed and the pinion is attached to a movable machine. In this type of rack and pinion arrangement, the rotation of the pinion causes the machine to move along the rack. Essentially, the rack is a path which the machine follows. This type of rack and pinion arrangement is also common in a variety of different machines. For instance, machine tools employ this principle to obtain rapid movements of a worktable. Generally, the rack and pinion arrangement is a pair of gears which convert rotational motion into linear motion.

The rack is typically a straight bar which allows a machine to move along a straight path as the teeth of the pinion meshes with the teeth of the rack. The rack may also be a circular bar with a constant radius which also allows a machine to move around a circular path as the teeth of the pinion meshes with the teeth of the rack. The conventional pinion is typically a high tolerance machined part made from a rigid material. However, due to rigid characteristics of the conventional pinion, the conventional pinion cannot move along a rack that has a straight section and a curved section. Rather, the conventional pinion can either move along a straight rack or a circular rack with a constant radius. Therefore, there is a need for a pinion that is capable of moving along a rack having a curved section and a straight section.

### SUMMARY OF THE INVENTION

The present invention generally relates to a motion transfer system that is capable of moving along a variable rack. In one aspect, a motion transfer system for moving an object along a path is provided. The system includes a variable rack having at least one straight section and at least one curved section and a drive system. The drive system includes a drive motor for supplying energy to the drive system, a rotatable pinion operatively connected to the drive motor, and a plurality of rollers disposed around the rotatable pinion, wherein the rollers are configured to self align as the pinion meshes with the variable rack.

In another aspect, a method of moving an object along a variable rack having at least one straight section and at least one curved section is provided. The method includes the step of positioning a motion transfer system with the object attached thereto on the variable rack, wherein the motion transfer system includes a motor and a pinion with a plurality of self adjusting rollers. The method further includes the step of rotating the pinion such that the plurality of self adjusting rollers mesh with a plurality of contact areas between the teeth on the rack, thereby moving the motion transfer system and the object along the variable rack. The method also includes the step of automatically adjusting each roller as it meshes with the contact area, wherein the rack includes at least one uniform contact area and at least one nonuniform contact area.

In a further aspect, a motion transfer system is provided. The motion transfer system includes a rack having a plurality of teeth, wherein each pair of teeth is separated by a contact area. The rack includes a straight section with a uniform contact area and a curved section with a nonuniform contact area. The motion transfer system further includes a drive system with a rotatable pinion, the rotatable pinion having a plurality of compliant rollers equally spaced around a perimeter thereof, whereby each compliant roller is configured to mesh with the uniform contact area and the nonuniform contact area.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a side view of a motion transfer system in accordance with the present invention.

FIG. 2 illustrates a front view of the motion transfer system.

FIGS. 3A and 3B illustrate a pinion in the motion transfer system.

FIG. 4 illustrates the motion transfer system on a rack.

FIG. 5 illustrates a plan view of the motion transfer system.

### DETAILED DESCRIPTION

In general, the present invention relates to a motion transfer system that is capable of moving along a variable rack, whereby the rack includes both positive and negative curves. The motion transfer system will be described herein in relation to a horizontal rack. However, it should be understood that the invention may be employed with a vertical rack or an angled rack without departing from the principles of the present invention. To better understand the novelty of the apparatus of the present invention and the methods of use thereof, reference is hereafter made to the accompanying drawings.

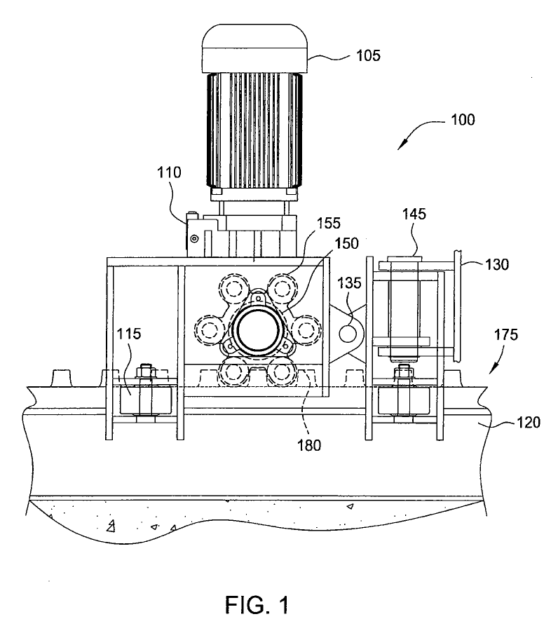

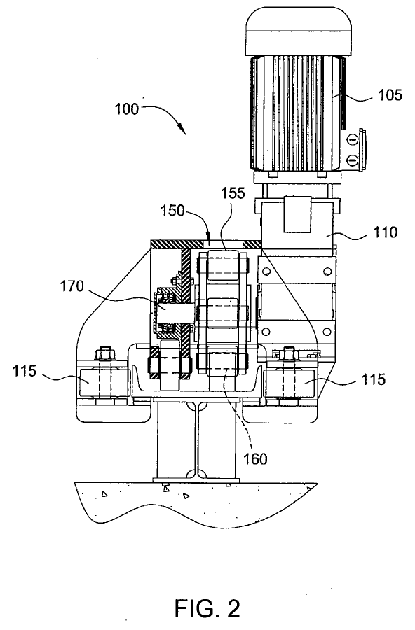

FIG. 1 illustrates a side view and FIG. 2 illustrates a front view of a motion transfer system 100 in accordance with the present invention. Generally, the motion transfer system 100 is configured to move a carriage 130 (or another component) along a rack 175. The rack 175 may have any number of negative curves, positive curves, transitions, and/or straight sections. As will be discussed herein, the motion transfer system 100 includes a self adjusting pinion 150 that interacts with the rack 175 disposed on a support member 120.

As shown in FIGS. 1 and 2, the pinion 150 includes a plurality of rollers 155. Essentially, the rollers 155 take the place of the teeth on a conventional pinion. The rollers 155 are configured to act in a compliant manner as the pinion 150 interacts with the rack 175. In other words, each roller 155 in the pinion 150 can self adjust as the roller 155 meshes with the teeth 180 in the rack 175. As such, the rollers 155 self align to find the best contact patch as the pinion 150 engages the rack 175.

Also illustrated in FIGS. 1 and 2, the motion transfer system 100 includes a drive motor 105 and a gearbox 110 for supplying energy to the motion transfer system 100. The drive motor 105 and the gearbox 110 are operatively attached to the pinion 150 via a shaft 170. The drive motor 105 and the gearbox 110 rotate the pinion 150, thereby causing the motion transfer system 100 to move along the rack 175. The pinion 150 interacts with the rack 175 to provide horizontal support to the motion transfer system 100. The motion transfer system 100 further includes a plurality of support rollers 115 that interact with the side of the support member 120 to provide vertical support to the motion transfer system 100. One set of support rollers 115 is connected to the main body of the motion transfer system 100 via a pin arrangement 135. The motion transfer system 100 also includes a pin 145 for connecting the motion transfer system 100 to the carriage 130.

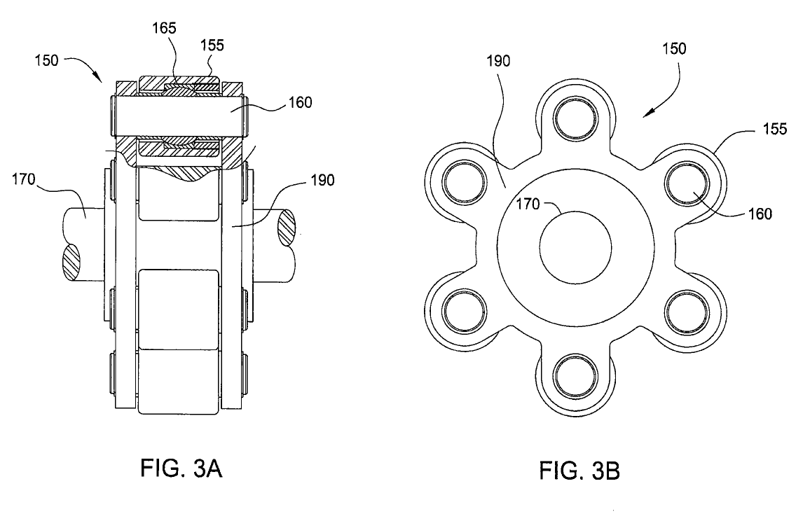

FIGS. 3A and 3B illustrate the pinion 150 in the motion transfer system 100. As shown, the pinion 150 includes six rollers 155 equally spaced around the pinion 150. It should be understood, however, that the pinion 150 may include any number of rollers, without departing from principles of the present invention. Each roller 155 is mounted to a shaft 160 via a bearing member 165. The bearing member 165 is configured to allow the roller 155 to have rotational movement relative to the shaft 160. The bearing member 165 is also configured to allow the roller 155 to have angular movement relative to the longitudinal axis of the shaft 160. In other words, the bearing member 165 allows both rotational movement and angular movement of the roller 155 relative to the shaft 160. In one embodiment, the angular movement of the roller 155 relative to the shaft 160 is about 4 degrees. The shaft 160 connects the roller 155 to a body 190 of the pinion 150. As a result, the roller 155 can rotate and twist relative to the body 190 of the pinion 150, thereby allowing the rollers 155 to self adjust as the pinion 150 meshes with the rack 175.

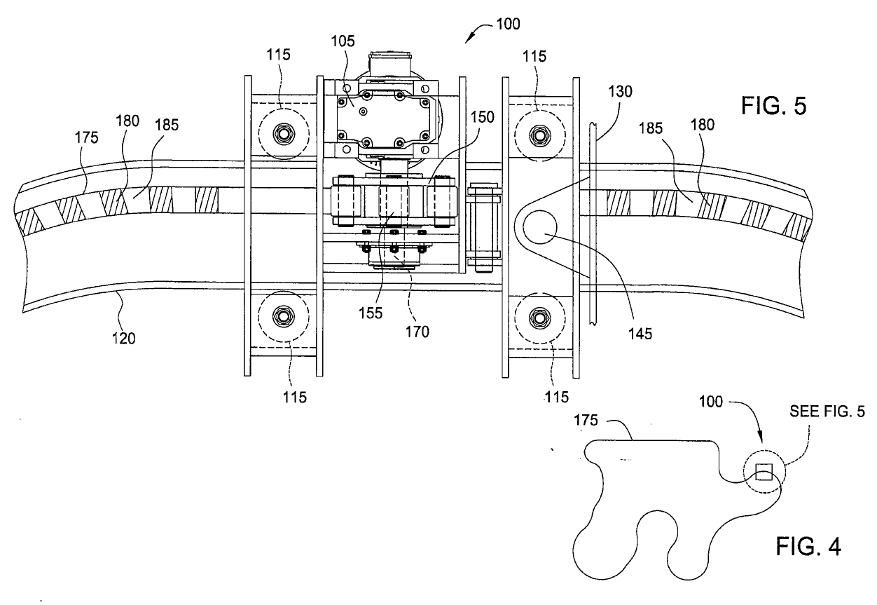

FIG. 4 illustrates the motion transfer system 100 on the rack 175. For clarity purposes, the rack 175 and the motion transfer system 100 are shown in a line format. The rack 175 is considered a variable rack since the rack 175 may include several negative curves, positive curves, transitions, and straight sections. As shown, the motion transfer system 100 is moving around a negative curve of the rack 175. In one embodiment, the rack 175 is made from several different pieces. Initially each piece of the rack 175 is substantially straight, thereby having a contact area 185 between the teeth 180 that is uniform (see FIG. 5). Generally, a uniform contact area means that a centerline of each tooth 180 is substantially perpendicular to a longitudinal axis of the rack 175. Each piece in a curved portion or transition portion of the rack 175 is subsequently shaped by placing the piece in a machine, such as a press brake, that is capable of forming the piece of the rack into a shaped configuration. However, as a piece of the rack is formed into the shaped configuration, the contact area 185 between the teeth 180 which was initially uniform becomes nonuniform. Generally, a nonuniform contact area means that each tooth 185 may have a taper relative to the longitudinal axis of the rack 175, as shown in FIG. 5. This type of manufacturing process is cost effective because the process does not require high tolerance machining as the curved portions and transition portions of the rack 175 are formed.

After each piece of the rack is made, the pieces are interconnected to form the rack 175. Due to the fact that the rack 175 may include curved portions, transition portions, and straight portions, the rack 175 will have sections that include uniform contact areas and sections that include nonuniform contact areas throughout the length of the rack 175. Additionally, it should be understood, that the rack 175 is not limited to the configuration illustrated in FIG. 4. Rather, the rack 175 may be configured in any manner without departing from principles of the present invention.

FIG. 5 illustrates a plan view of the motion transfer system 100. As shown, the motion transfer system 100 is on the curved portion of the rack 175. As the shaft 170 of the pinion 150 is rotated by the motor 105, the pinion 150 rotates relative to the rack 175, thereby causing the motion transfer system 100 to move along the rack 175. As the pinion 150 rotates, the rollers 155 seat within the contact area 185 between the teeth 180 of the rack 175. In one embodiment, at least one roller 155 engages the rack 175 at all times such that before one roller 155 disengages from the rack 175 another roller 155 engages the rack 175, thereby maintaining positive contact between the pinion 150 and the rack 175. As the rollers 155 engage the contact area 185 that is nonuniform, the rollers 155 self adjust (or self align) with the contact area such that the correct contact patch or optimum surface area contact between the pinion 150 and the rack 175 is established and maintained. As the motion transfer system 100 moves into a straight portion of the rack 175 where the contact area 185 is substantially uniform, the rollers 155 self adjust (or self align) with the uniform contact area 185 such that the correct contact patch or optimum surface area contact between the pinion 150 and the rack 175 is established and maintained. In this manner, the pinion 150 with the self adjusting rollers 155 allows the motion transfer system 100 to have the capability of moving along the entire rack 175 while maintaining optimum contact between the pinion 150 and the rack 175.

In another embodiment, the motion transfer system 100 may include a control system (not shown) that controls the motion transfer system 100 as it moves around the rack 175. The control system may include a control sequence that could be used to control any backlash in the motion transfer system 100. The control system may include sensors that are configured to measure the temperature and speed of the motion transfer system 100. The control system may also include a sensor that is configured to monitor the interaction of the rollers 155 and the contact area 185 between the teeth 180 of the rack 175 in order to maintain optimum contact between the pinion 150 and the rack 175. In another embodiment, a first motion transfer system 100 and a second motion transfer system 100 may be connected together. In this embodiment, a control system may be used to control the first and the second motion control system to eliminate backlash as both motion control systems 100 move around the rack 175.

In operation, a motion transfer system having a carriage or another component is connected thereto is placed on a rack. In one embodiment, the component is a robotic arm that is configured to move relative to the rack as the motion transfer system moves the robotic arm along the rack. In a further embodiment, the robotic arm may be used to transport cargo and/or at least one person. The rack may include several negative curves, positive curves, transitions, and straight sections. As a motor in the motion transfer system rotates a pinion, the motion transfer system moves along the rack. As the pinion rotates, a plurality of rollers on the pinion mesh with an area between the teeth of the rack. As the motion transfer system moves into a curved portion of the rack, the contact area between the teeth is nonuniform. As the rollers engage the contact area that is nonuniform the rollers self adjust (or self align) with the tapered area such that a correct contact patch or optimum surface area contact between the pinion and the rack is established and maintained as the motion transfer system moves through this portion of the rack. As the motion transfer system moves into a straight portion of the rack where the contact area between the teeth of the rack is substantially uniform, the rollers self adjust (or self align) with the uniform area such that the correct contact patch or optimum surface area contact between the pinion and the rack is established and maintained as the motion transfer system moves through this portion of the rack. In this manner, the motion transfer system is capable of snaking through the rack while maintaining optimum contact between the pinion and the rack.

The motion transfer system may be used in various industries. For instance, the motion control system may be used in the entertainment industry to move rides in an amusement park. The motion transfer system may also be used in the heavy machinery industry.

While the foregoing is directed to embodiments of the present invention, other and further embodiments of the invention may be devised without departing from the basic scope thereof, and the scope thereof is determined by the claims that follow.

1. A motion transfer system for moving an object along a path, the system comprising:
a variable rack having at least one straight section and at least one curved section; and
a drive system comprising:
a drive motor for supplying energy to the drive system;
a rotatable pinion operatively connected to the drive motor; and
a plurality of rollers disposed around the rotatable pinion, wherein the rollers are configured to self align as the pinion meshes with the variable rack.

2. The system of claim 1, wherein the at least one curved section includes both positive curves and negative curves.

3. The system of claim 1, wherein each roller is attached to the rotatable pinion via a shaft.

4. The system of claim 3, wherein each roller is attached to the shaft via a bearing.

5. The system of claim 4, wherein the bearing allows angular movement of the roller relative to a longitudinal axis of the shaft and rotational movement of the roller relative to the shaft.

6. The system of claim 1, wherein the object is a robotic arm.

7. The system of claim 1, further including a plurality of side rollers configured to provide vertical support to the motion transfer system.

8. The system of claim 1, wherein the rack includes a plurality of teeth, whereby each pair of teeth is separated by a contact area.

9. The system of claim 8, wherein the rack includes sections that have a uniform contact area and a nonuniform contact area.

10. The system of claim 9, wherein a centerline of each tooth is substantially perpendicular to a longitudinal axis of the rack in the uniform contact area.

11. The system of claim 9, wherein each tooth is tapered relative to a longitudinal axis of the rack in the nonuniform contact area.

12. A method of moving an object along a variable rack having at least one straight section and at least one curved section, the method comprising:
positioning a motion transfer system with the object attached thereto on the variable rack, the motion transfer system having a motor and a pinion with a plurality of self adjusting rollers;
rotating the pinion such that the plurality of self adjusting rollers mesh with a plurality of contact areas between a plurality of teeth on the variable rack, thereby moving the motion transfer system and the object along the variable rack; and
automatically adjusting each roller as it meshes with the contact area, wherein the rack includes at least one uniform contact area and at least one nonuniform contact area.

13. The method of claim 12, wherein a centerline of each tooth is substantially perpendicular to a longitudinal axis of the rack in the uniform contact area.

14. The method of claim 12, wherein each tooth is tapered relative to a longitudinal axis of the rack in the nonuniform contact area.

15. The method of claim 12, wherein the uniform contact area is on the at least one straight section and the nonuniform section is on the at least one curved section.

16. The method of claim 12, wherein the at least one curved section includes both positive curves and negative curves.

17. The method of claim 12, wherein each roller is configured to have rotational movement and angular movement relative to the pinion.

18. A motion transfer system, the system comprising:
a rack having a plurality of teeth, wherein each pair of teeth is separated by a contact area, the rack having a straight section with a uniform contact area and a curved section with a nonuniform contact area; and
a drive system with a rotatable pinion, the rotatable pinion having a plurality of compliant rollers equally spaced around a perimeter thereof, whereby each compliant roller is configured to mesh with the uniform contact area and the nonuniform contact area.

19. The system of claim 18, wherein the curved section includes both positive curves and negative curves.

20. The system of 18, wherein each compliant roller is configured to have rotational movement and angular movement relative to the pinion.
